(19) United States
(12) Patent Application Publication
(10) Pub. No.: US 2001/0040422 A1
(43) Pub. Date: Nov. 15, 2001

(54) Method and system for providing and using a parcel keeper

(76) Inventor: Jeffrey D. Gramlich, Honolulu, HI (US)

Correspondence Address: Jeffrey D. Gramlich, Manager, ParcelKeeper LLC, 2523 Pamoa Road, Honolulu, HI, 96822, US

(21) Appl. No.: 09/827,287

(22) Filed: Apr. 6, 2001

Related U.S. Application Data
(60) Provisional application No. 60/195,024, filed on Apr. 6, 2000.

(51) Int. Cl. B42F 21/00; G06F 17/00; H04Q 1/30

(52) U.S. Cl. 312/234; 705/404; 340/532; 340/534

(57) ABSTRACT

A method and system for receiving and returning packages using a parcel keeper receptacle. A parcel keeper receptacle is a lockable box secured, locked or attached at a delivery address accessible by delivery persons with the interior accessible using an access code, optionally having an indicator specifying whether a package is inside. The parcel keeper unit itself provides a secure mechanism for delivery of packages. The method of access to a parcel keeper receptacle is a combination code controlled by the owner. The owner purchases an item via the Internet, catalog, telephone or other mechanism that requires delivery. Preferably, the purchaser provides the seller with the parcel keeper code on the address line at the time of placing an order. Alternately, the purchaser may inform the seller using another method, such as verbally informing the seller, that the delivery person is to use the parcel keeper receptacle for delivery. The delivery person uses the parcel keeper code as provided and places the package into the parcel keeper receptacle. The owner is then able to retrieve the package using the owner's master code. The invention allows for the safe and convenient delivery of packages in the absence of the resident at the address. The delivery is facilitated due to the use of the parcel keeper and the carrier is able to complete the delivery without having to return to the address at a later date due to the fact that no one is present to accept delivery. Additionally, the parcel keeper process facilitates the easy return of merchandise. The owner of the parcel keeper places the item in the receptacle for pick up and enters the parcel keeper code in the address line of the return label. The delivery person returns to the address, uses the parcel keeper code provided and retrieves the package without human interaction. Thus, the unmanned, but secure, delivery and return of merchandise is assured by the parcel keeper process.

### CROSS REFERENCE TO RELATED APPLICATIONS

This application claims the priority of a related provisional patent application that has been assigned US Patent and Trademark Office application Ser. No. 60/195,024.

### FIELD OF THE INVENTION

The present invention relates to shipment of parcels to parties, especially shipment by businesses that ship products directly to customers, such as shipping businesses and e-commerce businesses, and more particularly to a method and system for allowing such products to be delivered rapidly and securely.

### BACKGROUND OF THE INVENTION

Increasingly, products purchased on the Internet, on television, and in catalogs are being delivered to consumers' homes and offices by delivery services such as UPS, FedEx, Airborne, DHL and national postal services. Problems arise when packages can't be delivered because the addressee is not present to accept delivery. Current possibilities for receiving the package can be costly, inefficient and subject to property loss. Addressees can ask that the package be redelivered at an alternate time, request that the parcel be left with a neighbor, or they can simply disregard the issue and the package is left on the doorstep, unprotected from theft and weather.

Accordingly, what is needed is a system and method for ensuring rapid, secure delivery of parcels to the addressees. The present invention addresses such a need.

### SUMMARY OF THE INVENTION

The present invention provides a method and system for providing and using a parcel keeper. A parcel keeper is a lockable box secured, locked or attached at a delivery address accessible by delivery persons with the interior accessible using an access code, optionally having an indicator specifying whether a package is inside. Optionally, the parcel keeper can be installed either by a consumer or by a delivery person. The parcel keeper unit itself provides a secure mechanism for delivery of packages. Preferably, the unit is weatherproof, can keep its contents secure and is difficult for a thief to remove from the premises. In one embodiment, the unit can be collapsible to be easily stored when not in use. Thus, the unit can securely accept delivery of parcels, packages and groceries, and can secure them at the addressee's location in an attractive weather- and theft-resistant receptacle. The addressee, the shipping company and the shipper can use the unit to ensure secure rapid delivery of packages, as explained herein. For example, when purchasing a product to be delivered, the consumer/addressee can notify the vendor/shipper of the existence of the parcel keeper unit and instruct the shipper as to how to access the unit. The shipper passes this information on to the shipping company, which delivers the product to the unit and, in one embodiment, receives confirmation of the delivery. Alternatively, the shipper or shipping company could provide the unit and instruct the addressee as to how to access the contents of the unit. The shipping company could later retrieve the unit or allow the addressee to purchase the unit. In such an embodiment, the unit could be collapsible for ease of storage by the shipping company or addressee. Furthermore, other information relating to the unit could be kept for use, for example for security and tracking purposes, by the addressee, the shipping company, or law enforcement.

According to the system and method disclosed herein, the present invention provides a method and system for rapidly and securely delivering packages.

### BRIEF DESCRIPTION OF THE DRAWINGS

FIG. 1 is a diagram of one embodiment of a parcel keeper unit in accordance with the present invention. This embodiment is can easily be constructed using pre-fabricated fitted and molded parts and incorporates the following features:

A mail slot (101) to accept delivery of paper documents without requiring the delivery person to open the container;

A manual or electronic combination lock (102) for opening the container to insert or retrieve packages;

Holes in the rear of the unit (103) for securing the container to an immovable device;

Holes in the base (104) for securing the container to the floor; and

A two-way indicator (105) to indicate whether a package has yet been delivered.

FIG. 2 A-G is a diagram of another embodiment of a parcel keeper unit in accordance with the present invention. Versions A-G are provided on separate pages to demonstrate the stages of unfolding from a compact, easily storable unit to an expanded parcel keeper capable of receiving packages. This embodiment can be easily constructed using sliding and folding parts that are not separable from one another, to ease preparation for service and to prevent loss of parts. This embodiment incorporates the following features:

A manual or electronic combination lock (201) for opening the container to insert or retrieve packages;

Holes in the side and rear of the unit (202) for securing the container to an immovable device; and

A two-way indicator (203) to indicate whether a package has yet been delivered;

A hinge to lift the lid of the container (204);

The lid of the container stores the front and side walls to be extracted (205); and

A guided slot (206) with which to slide the lid forward upon securing the front and side walls in place.

FIG. 3 is a flow chart that illustrates the process used in having an item delivered to the parcel keeper.

FIG. 4 is a flow chart that illustrates the process used in having an item picked-up from the parcel keeper.

### DETAILED DESCRIPTION OF THE INVENTION

The present invention relates to an improvement in shipment of goods, for example for e-businesses. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention will be described in terms of particular embodiments of the parcel keeper unit and methods for its use. However, one of ordinary skill in the art will readily recognize that this method and system will operate effectively for other embodiments of the parcel keeper unit and uses not inconsistent with the present invention.

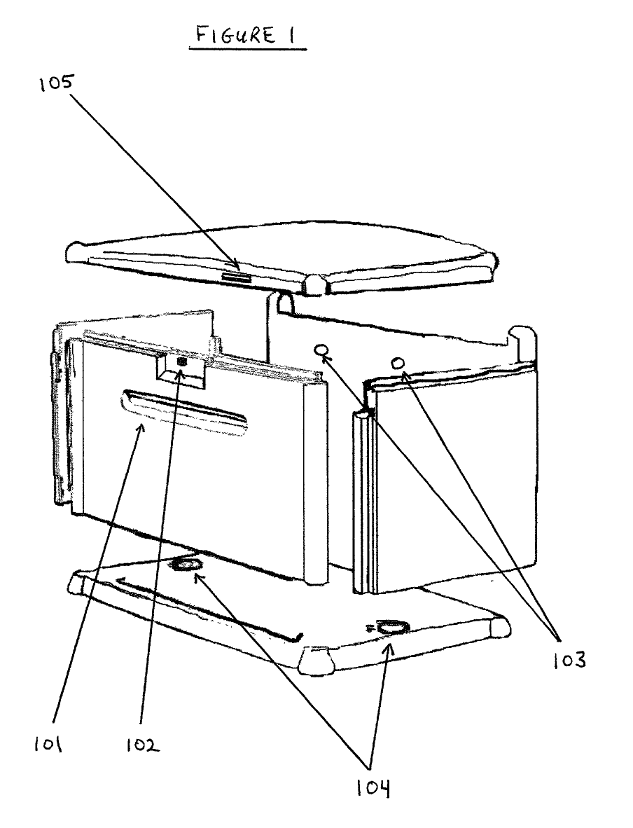

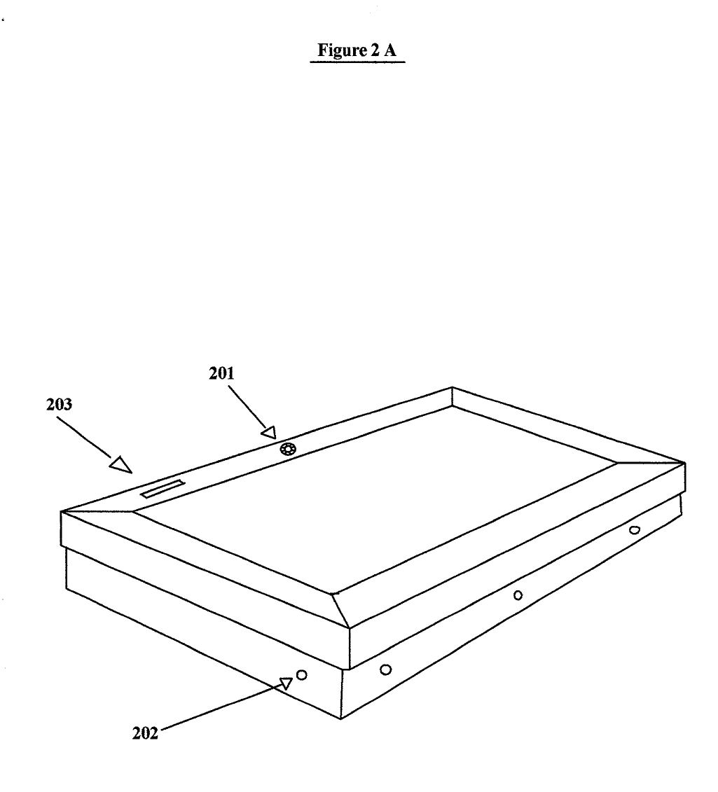

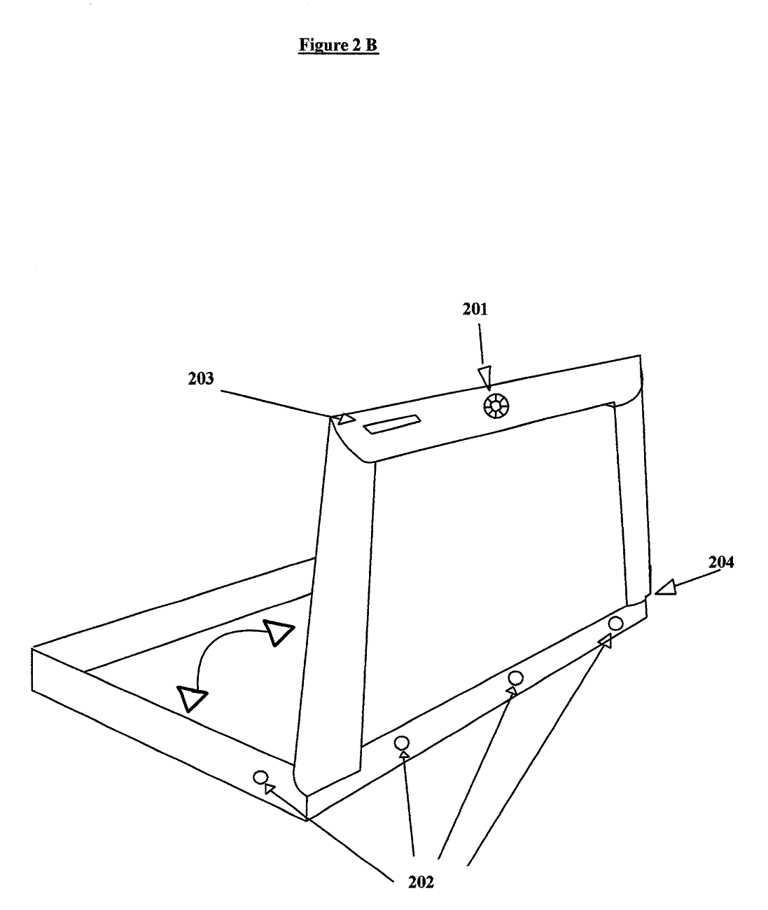

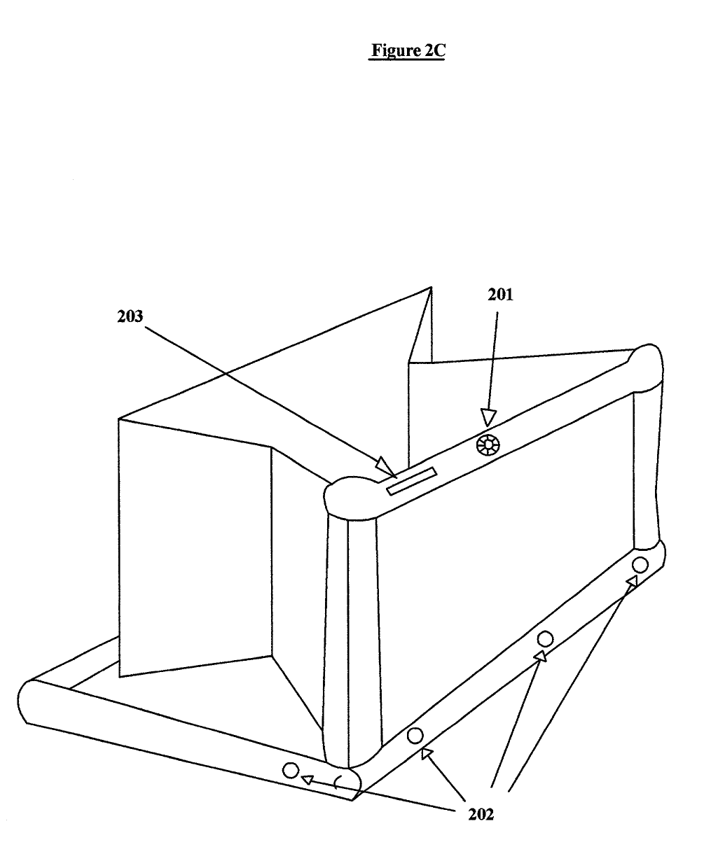

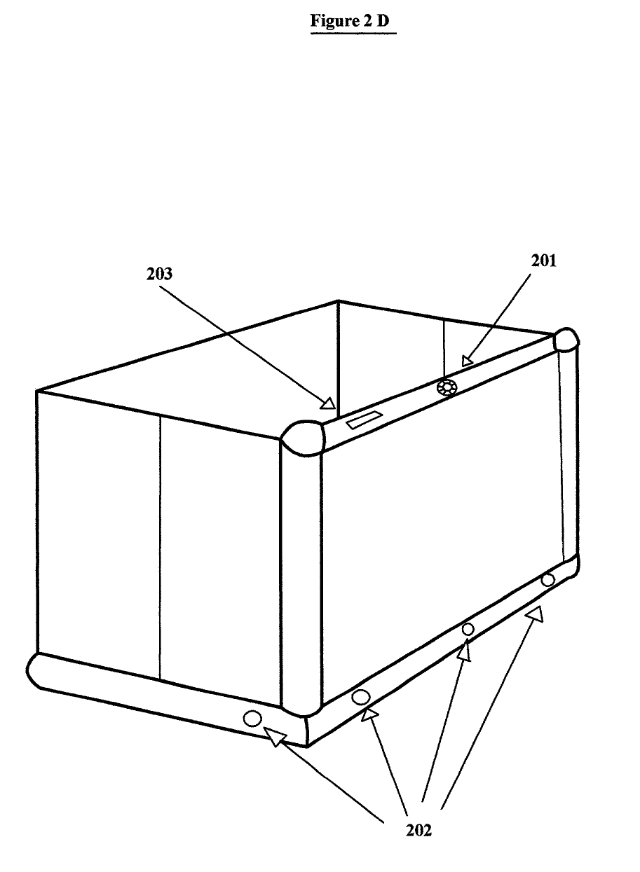

To more particularly illustrate the method and system in accordance with the present invention, refer now to FIGS. 1 and 2, depicting embodiments of the parcel keeper unit in accordance with the present invention. One aspect of this process is a parcel keeper unit, one embodiment of which is an attractive receptacle (17″×24″×17″). One embodiment of the parcel keeper is depicted in FIG. 1. The parcel keeper is placed outside of homes and offices to receive or ship parcels when no one is present to receive or ship them.

One embodiment of the parcel keeper unit is depicted in FIG. 1. This embodiment of the parcel keeper will preferably be a two-piece molded-plastic container with five sides (four walls and a bottom) and a hinged lid. The size of the box is approximately 17″ tall ×24″ wide ×17″ deep, with other sizes to follow. The lid can lock using a simple combination lock or other locking mechanism. The entire container will be capable of being secured via large screws or bolts through the bottom or back that can be attached to a porch, house, or other structure. The container will be capable of being locked like a bicycle to porch poles or other stationary objects using either a bicycle cable or U-shaped steel lock. In another embodiment, the parcel keeper unit could use some other mechanism to make the receptacle itself difficult to steal. One purpose of the initial version is to provide consumers with a secure receptacle for the delivery of parcels from and to delivery companies such as the US Postal Service, FedEx, Airborne, DHL and UPS,

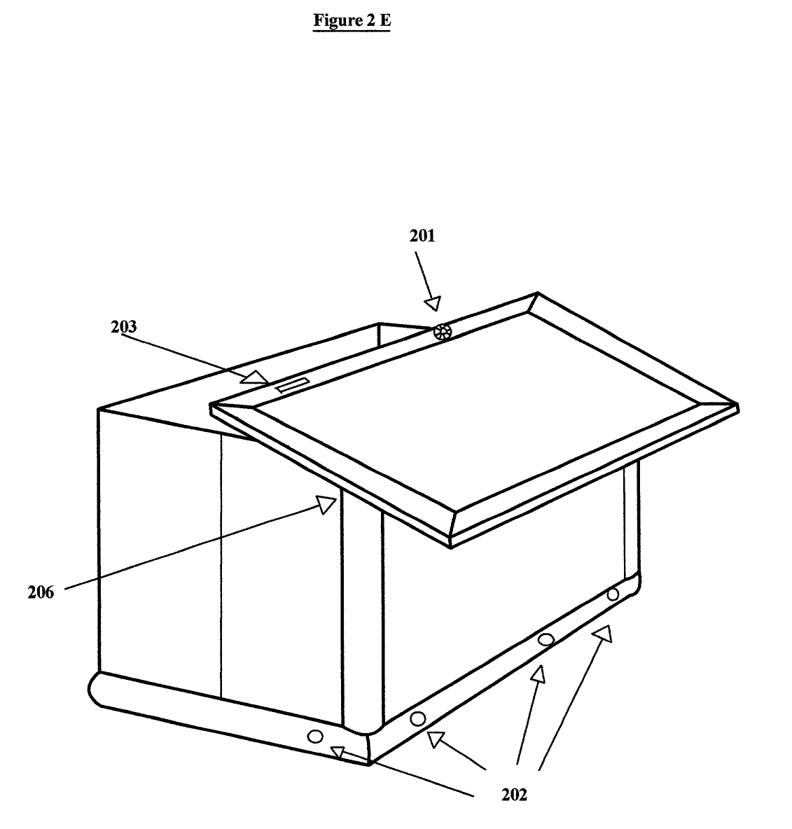

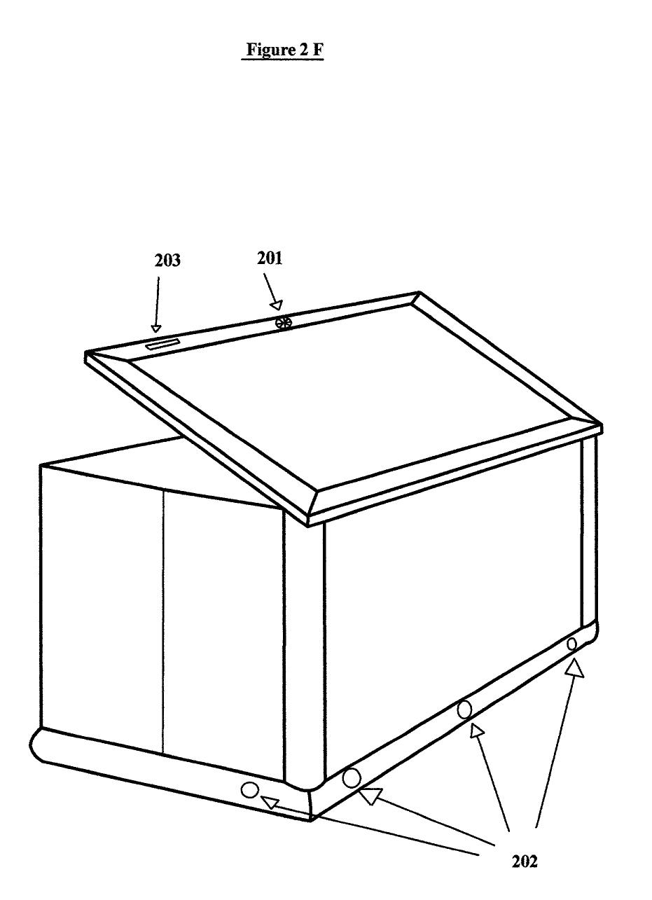

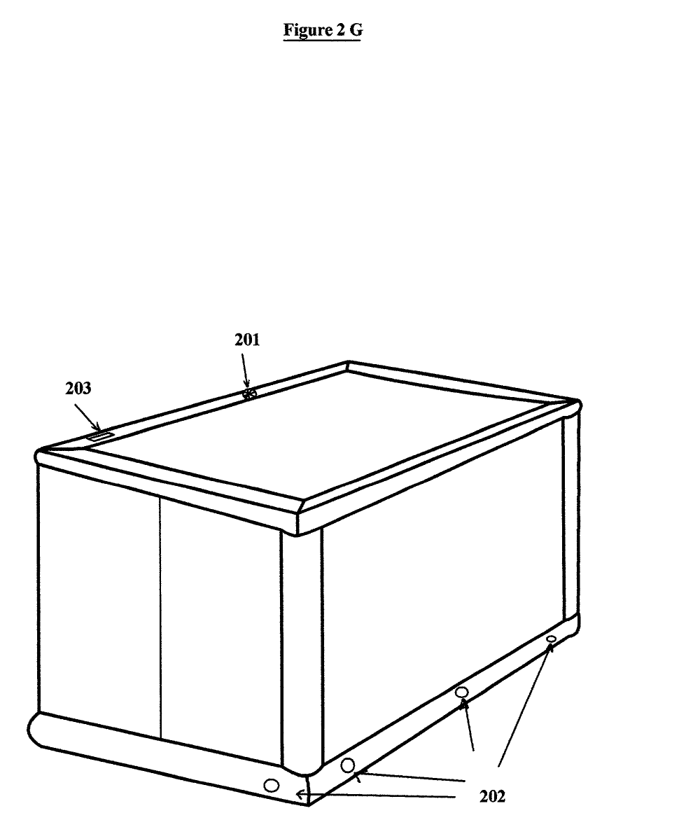

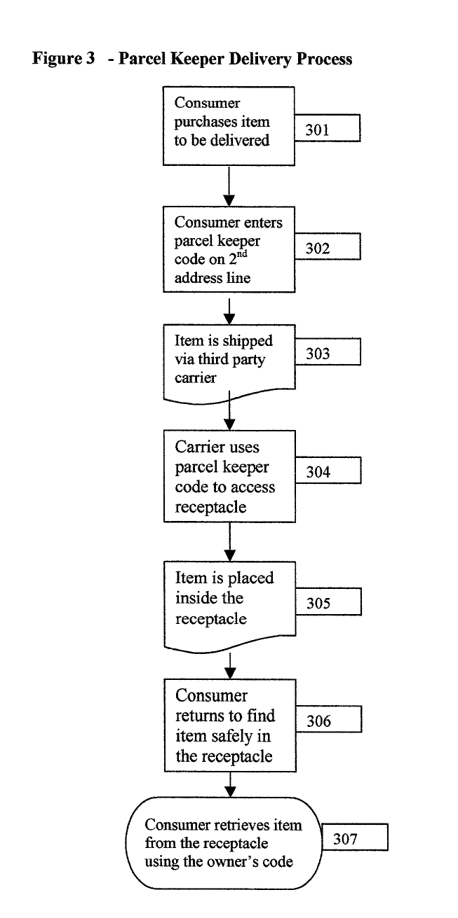

The present invention also includes a method for using the parcel keeper unit (“unit”) in shipping and/or commerce (FIG. 3). When purchasing a product through a catalog, online, or over the telephone 301, the purchaser can provide the seller with the unit's combination as part of the mailing address that is given 302. In the alternative, the purchaser may not need to provide the combination. Instead, another method of access could be used. For example, some packages could fit through a slot that might be provided in the unit. However, the slot would preferably be configured so that the packages are inaccessible except by unlocking the unit. Alternatively, the purchaser could provide notification of the unit to the seller and/or the shipping company in another fashion. For example, when the item is delivered, the purchaser could also notify the shipping company of the location of the unit and the fact that delivery is to take place using the unit. The purchaser could place a (pre-printed) note on the door or in another conspicuous location. The note will request the delivery person to place the parcel inside the unit using the combination that is on the address label or through the slot, if appropriate. The delivery person will use the combination to open the unit and place the parcel inside 304, 305. A notice affixed to the unit could request that the delivery person change the position of a switch, flag or other indicator that is installed on the unit to reflect whether a parcel has been delivered. Another possibility (pictured in FIG. 1) is that the unit will have a window to allow an owner to view inside to determine whether a parcel has been delivered. In another embodiment, the unit may have an automatic mechanical or electronic indicator that is activated when a parcel has been placed in the unit.

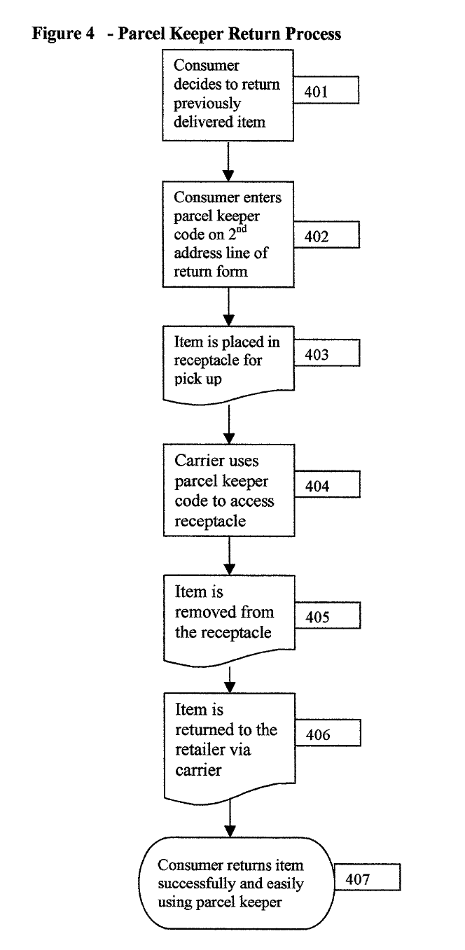

The present invention also includes a method for using the parcel keeper unit (“unit”) in pick-up and return of products (FIGS. 4). When returning a product purchased through a catalog, online, or over the telephone 401, the purchaser can provide the seller with the unit's combination as part of the return label address that is given 402. Alternatively, the purchaser could provide notification of the unit to the seller and/or the shipping company in another fashion. For example, when the item is picked up, the purchaser could also notify the shipping company of the location of the unit and the fact that pick up is to take place using the unit. The purchaser could place a (pre-printed) note on the door or in another conspicuous location. The note will request the delivery person to remove the parcel from inside the unit using the combination that is on the return address label or through the slot, if appropriate. The delivery person will use the combination to open the unit and remove the parcel from inside 404, 405. A notice affixed to the unit could request that the delivery person change the position of a switch, flag or other indicator that is installed on the unit to reflect whether a parcel has been picked up. Another possibility (pictured in FIG. 1) is that the unit will have a window to allow an owner to view inside to determine whether a parcel has been picked up. In another embodiment, the unit may have an automatic mechanical or electronic indicator that is activated when a parcel has been removed from the unit.

In addition to serving all of the purposes of the unit depicted in FIG. 1, other embodiments of the unit could be easily foldable or collapsible, yet secure in their expanded states. These embodiments also could be locked or otherwise affixed to surrounding fixed objects. Other mechanisms for making the units difficult to steal could also be employed. Another embodiment of the unit is depicted in FIG. 2.

For example, another embodiment of the unit could have a digital lock that has one or more full-time combinations for the owner or owners. The digital lock could allow entrance to the unit only one time for each parcel, in order to avoid the security risk of permanent combinations that may be revealed to potential thieves. This embodiment of the unit may work in much the same way as the initial embodiment depicted in FIG. 1, except that it can require that delivery representatives use unique combinations for each parcel. The combinations could be, at least in part, the shipping company's tracking number. A small computer and printer could record the date and time of each entrance to the unit by each combination holder. The printer will produce a small paper receipt for delivery persons (and their companies) to provide evidence that a particular parcel has been delivered to a particular unit. Thus, a shipping company is provided with confirmation of the delivery to the unit. Another embodiment of the unit (not shown) could include multiple, preferably separately lockable portions in the event of multiple deliveries. Preferably, such a unit would be capable of providing separate confirmation of each delivery made for a different portion of the unit.

Preferably, each unit will have a unique serial number. The serial numbers and the owners' names and addressees can be registered in an ownership database. The database can serve several functions. First, it can provide a security function; owners will report to the database when and if their unit has been stolen. This will tell delivery companies not to deliver parcels to this unit. More importantly, the database can serve as a central record for each unit's contents. When a parcel is delivered, the database can be updated to reflect that the particular unit has received a parcel. Recorded on the database can be the parcel's tracking number, and the date and time of its delivery. Using e-mail, a computerized voice messaging system or another system, the owner will be informed of the parcel's delivery. Using a web or similar connection, the owner will also be able to view a complete record of parcels delivered to the unit.

In addition, another version of the unit could utilize a digital lock that employs scanning technology. With scanning technology, delivery company representatives could be allowed access by simply scanning the parcel's bar-coded mailing label; owners will able to access the unit with a bar-coded credit card-sized card. The owners will be able to gain access to the unit by scanning the card. The unit should also be capable of recording the parcel's tracking number, and date and time. A receipt could be printed upon the delivery of each parcel, indicating the date and time that the parcel has been delivered. Thus, the shipping company could be provided with an indication that delivery has been made.

Embodiments of the unit employing a digital lock could also have electronic indicators to replace the manual indicator. These units could allow owners (and only owners) to determine whether a parcel has been delivered, using either scanning or unique sound-recognition electronic technology.

These alternate embodiments of the unit may thus provide the following advantages

providing a more secure receptacle (each combination released to a delivery company can only be used one time),

providing evidence that a delivery has been made when no one is home to sign for it, and

permitting space-saving storage of the receptacle.

In using these alternate embodiments of the units, the business process in accordance with the present invention could be expanded in comparison with the process used for the embodiment of the unit depicted in FIG. 1. In addition to serving the same basic functions as the embodiment of the unit depicted in FIG. 1, alternate embodiments of the unit may be capable of being used with the following process:

When a delivery person finds that an addressee is not present to receive a parcel, the delivery person may choose to unfold one of these units that is being carried in the delivery vehicle.

Upon unfolding, the delivery person will affix the unit to an immovable object near the addressee's door or otherwise takes steps to ensure that the unit is difficult to steal.

To open, the delivery person can either scan the package to the unit's installed scanner or enter a unique combination to the digital lock.

Before closing the unit, the delivery person will place the parcel inside the unit.

Upon closing the unit, the installed printer will print a receipt for the receipt of the parcel—this receipt will be evidence used by the delivery company to document that a delivery has been made.

A method and system has been disclosed for providing and using a parcel keeper. Although the present invention has been described in accordance with the embodiments shown, one of ordinary skill in the art will readily recognize that there could be variations to the embodiments and those variations would be within the spirit and scope of the present invention.

### Industrial Applicability

This invention can be used whenever it is desired to provide for a secure receptacle to which packages can be delivered and from which packages can be retrieved.

What is claimed is:

1. A process for delivering packages to purchasers comprising:
securing to a purchaser's delivery address a lockable container that unlocks in response to a purchaser-selectable code;
selecting a code for unlocking said container;
ordering a package for delivery to said delivery address;
entering said code into the delivery address for the package;
locking said container;
delivering said package to said container by entering the code from the delivery address on the package and inserting the package into the container and locking said container with the package inside;
entering said code to unlock said container; and
retrieving said package.

2. A process according to claim 1, wherein said selecting can be repeated multiple times by said user wherein said user can select a different code on each occurrence.

3. A process according to claim 1, further comprising adding an indicator operably connected to said container to indicate when a package has been inserted.

4. The method of claim 3, comprises the use of a window through which the inside of the receptacle can be viewed.

5. The method of claim 3, comprises the use of an external lever or indicator to indicate when a package has been inserted.

6. The method of claim 3, comprises the use of an electronic device to notify the owner when a package has been inserted.

7. A method for providing an access code to a lockable container having a lock at a destination address, comprising:
providing an address field having adequate space; and
inserting said access code into the address field.

8. A method of claim 7, comprises otherwise informing the delivery agent of the code, such as verbal notification.

9. A method of claim 7, comprises the use of a digital scanner that allows access to the receptacle for that particular parcel.
A process for delivering packages to purchasers comprising:
receiving an order for a package for delivery to a delivery address;
entering said code into said lock for unlocking said container that has been secured to the delivery address whereby a delivery person can insert a package into the container and lock said container with the package inside and whereby a recipient can enter said code to unlock said container and retrieve said package;

10. A process according to claim 1, wherein said purchaser-selectable code can be changed by said user.

11. A method of claim 10, comprises the use of a digital lock that can be programmed by said user.

12. A method of claim 10, comprises the use of a combination lock for which the code can be changed by said user.

13. A process according to claim 1, providing a receipt to deliverer upon delivering the package to the container.

14. A method of claim 13, comprises the use of a manually printed receipt that is placed in the locked receptacle to be taken by the deliverer after placing the package inside.

15. A method of claim 13, comprises the use of a printed receipt generated by a receipt printer located inside said locked container.

16. A process for delivering packages to common carriers comprising:
securing to an address a lockable container that unlocks in response to a sender-selectable code;
a sender placing an item for delivery via common carrier into said lockable container;
said sender selecting a code for unlocking said container;
said sender conveying said code to a common carrier via telephone, fax, e-mail, or web transmission;
said common carrier entering said code into the lock of said lockable container to open said container; and
said common carrier retrieving said item from said lockable container for delivery to an intended recipient.
